(19) United States
(12) Patent Application Publication
(10) Pub. No.: US 2025/0235857 A1
(43) Pub. Date: Jul. 24, 2025

(54) UNSUPPORTED BIMETALLIC HYDROGENATION CATALYST, ITS PREPARATION AND APPLICATION THEREOF

(71) Applicants: CHINA PETROLEUM & CHEMICAL CORPORATION, Beijing (CN); SINOPEC RESEARCH INSTITUTE OF PETROLEUM PROCESSING CO., LTD., Beijing (CN)

(72) Inventors: Huandi HOU, Beijing (CN); Ting WANG, Beijing (CN); Ming DONG, Beijing (CN); Mengying TAO, Beijing (CN); Yi ZHAO, Beijing (CN); Jun LONG, Beijing (CN)

(21) Appl. No.: 18/698,150

(22) PCT Filed: Oct. 21, 2022
(86) PCT No.: PCT/CN2022/126700

§ 371 Date: Apr. 3, 2024

(30) Foreign Application Priority Data
Oct. 25, 2021 (CN) 202111244221.X
Oct. 25, 2021 (CN) 202111244222.4
Oct. 25, 2021 (CN) 202111244223.9

(51) Int. Cl. B01J 31/22; B01J 37/04; C10G 45/48

(52) U.S. Cl. CPC B01J 31/2226; B01J 37/04; C10G 45/48; B01J 2231/645; B01J 2231/646; B01J 2531/0208; B01J 2531/64; B01J 2531/847

(57) ABSTRACT

Disclosed is an unsupported bimetallic hydrogenation catalyst, its preparation and application thereof. The catalyst is composed of a complex formed by bonding a metal central atom or central ion with an organic ligand through a coordination bond, and has a schematic composition represented by formula (I): M¹M²Oₐ[R(COO)ₓ]_{b} (I), in which M¹ and M² represent metals, R(COO)ₓ represents an organic ligand, R represents the hydrocarbyl group of the organic ligand, COO represents the coordinating group of the organic ligand, x represents the number of coordinating groups in the organic ligand, a represents the molar ratio of oxygen atom linked to the metal via a non-coordination bond to the total amount of the metal, and b represents the molar ratio of the organic ligand to the total amount of the metal. When used for hydrogenation of hydrocarbons, the catalyst and composition thereof show high dispersibility in oil phase, high hydrogenation activity and high selectivity to target product.

### TECHNICAL FIELD

The present application relates to the field of hydrogenation catalysts, particularly to an unsupported bimetallic hydrogenation catalyst, its preparation and application thereof.

### BACKGROUND ART

In 2020, the external dependency of Chinese crude oil is over 70%, the imported crude oil is mostly the inferior and heavy crude oil from the Middle East and South America, in which the residual oil accounts for over 50%. Therefore, an effective utilization of petroleum resource, particularly a deep processing of the residual oil, can improve the utilization rate of the petroleum resource, and relieve the energy safety crisis of China.

In the crude oil processing, supported catalysts are hydrogenation catalysts that have been studied for the longest time, and applied most widely in largest number of industrial applications. Supported catalysts are composed of three components, namely a catalytic active component, an auxiliary catalytic active component and a carrier, wherein the active component and the auxiliary catalytic active component are mainly metals, and the carrier is a silicon-based or aluminum-based material or a porous material such as alumina, silica, kaolin, molecular sieve and the like. In order to improve the properties of the metal active sites on the catalyst, increasing the activity, selectivity and stability of the catalyst, hydrogenation catalysts was developed towards bimetallic and polymetallic catalysts. The hydrofining catalysts for distillate oil mostly adopt Mo—Ni and W—Ni hydrofining catalysts, the hydrogenation pretreatment of vacuum distillate oils mostly adopt W—Mo—Ni catalysts. Non-noble metal hydrogenation catalysts, such as, Mo, W and Ni mostly are present in a sulphide form and are loaded in pore channels of the carrier. As to the effect of the assistant metal elements, there are theories such as an embedding model (a structure where Co or Ni is embedded in MoS₂ or WS₂), a synergistic model (a structure where Co is present as Co₉S₈), a single layer model (a structure where MoO₃ or WO₃ is distributed on the carrier as a single layer) and the like to explain the influence of the assistant metal elements on the main metal sulphide structure or the distribution of the main metal elements on the carrier.

Because existing bimetallic catalysts are all supported catalysts, hydrogenation reaction of hydrocarbons catalyzed by such catalysts belongs to heterogeneous catalytic reaction, which involves seven stages: namely, molecules of the feedstock diffuse to the outer surface of the catalyst→the molecules of the feedstock diffuse into the pore channel of the catalyst→the molecules of the feedstock are adsorbed onto the active center of the catalyst→the molecules of the feedstock undergo surface catalytic reaction with the active center of the catalyst→reaction products are desorbed from the surface of the active center of the catalyst→the reaction products diffuse outwards from the pore channel of the catalyst→the reaction products diffuse to a liquid phase system from the outer surface of the catalyst. Among those stages, the diffusion stage significantly influences the occurrence probability and efficiency of the hydrogenation reaction catalyzed by supported bimetallic hydrogenation catalysts, and limits the catalytic activity of the catalyst.

To improve the dispersion degree and oil solubility of the catalyst, a number of researchers in the domestic and overseas have carried out related researches. Chinese patent No. ZL201510275523.1 discloses an oil-soluble Mo—Ni bimetallic catalyst, its preparation and application thereof. In the method disclosed, nickel nitrate and ammonium molybdate are dissolved into 15-25 times by mass of distilled water, a small amount of glycol is added, and then ammonia water is added into the solution to adjust the pH value to an alkaline range; the solution is heated to a temperature of 130-160° C. under stirring and reacted for 3-5 h, and the resultant is filtered to obtain a solid intermediate product; the solid intermediate product is dried at 100° C. under normal pressure, mixed with oleic acid, and reacted at 230-260° C. for 2-4 h to obtain the oil-soluble Mo—Ni bimetallic catalyst. The catalyst has flexible and adjustable bimetallic mass ratio, high hydrogenation activity and good coke inhibiting effect. However, in the patent, glycol and ammonia water are added in the first step, the reaction product obtained in the first step is filtered to obtain an intermediate product, and the intermediate product is dried and then subjected to the second step of reaction, and therefore the procedures of the method are complicated, waste is generated by filtering, and the metal content of the target product is low.

Chinese patent No. ZL201610862714.2 discloses a molybdenum-nickel catalyst for hydrocracking and a method for the preparation thereof. In the method, a hexavalent molybdenum source compound is dissolved and dispersed in a solvent, an inorganic acid catalyst and C1-C5 organic acid is added to react for 0.5-10 h at a temperature of 40-150° C., C6-C16 organic acid or C6-C16 ester are added to the reaction product obtained in step (1) to react for 2-22 h at a temperature of 160-320° C.; the product obtained in step (2) is cooled to 20-80° C., a nickel-containing inorganic material is added, and the resultant is reacted for 3-10 h at 50-95° C., and then heated to 100-180° C. and then reacted for 1-8 h; and the product obtained in step (3) is separated to remove the solvent phase, the oil phase is washed with water, and light components is removed by reduced pressure distillation to obtain the molybdenum-nickel hydrocracking catalyst. When used in heavy oil hydrocracking reaction, the catalyst shows high conversion rate and high yield of light oil. However, the method for the preparation of the catalyst has the disadvantages of large number of steps, complicated operation, expensive starting materials, generation of a large amount of wastewater due to the washing of reaction products with water, and poor environmental performance. In addition, the two metals are added at different times and steps during the synthesis, and the final synthesized product cannot be determined to be a mixture of two metal-organic compounds or a single bimetallic-organic compound.

U.S. Pat. No. 7,842,635B2 discloses a method for preparing an oil soluble bimetallic catalyst. In the method, a molybdenum source compound is reacted with an organic carboxylic acid in a mixed gas flow of N₂ and H₂ to obtain an molybdenum-organic compound; another metal compound is reacted with an organic carboxylic acid to obtain a corresponding metal-organic compound; and the two metal-organic compounds are mixed at a predetermined ratio to obtain the bimetallic-organic mixture. However, the above method involves a gas-liquid-solid three-phase reaction, of which the conversion rate is low, the energy consumption is high, and a large amount of waste water, waste gas and solid waste products will be generated.

### DISCLOSURE OF THE INVENTION

An object of the present application is to provide an unsupported bimetallic hydrogenation catalyst, its preparation and application thereof, which catalyst comprises a metal-organic complex having high oil phase dispersity, and when used to catalyze the hydrogenation reaction of hydrocarbon compounds, the reaction belongs to a homogeneous catalysis reaction, thereby eliminating the diffusion stage of the heterogeneous catalysis reaction, which is beneficial to improving the hydrogenation activity.

To achieve the above object, in one aspect, the present application provides an unsupported bimetallic hydrogenation catalyst, composed of a complex formed by bonding a metal central atom or central ion with an organic ligand through a coordination bond, and has a schematic composition represented by formula (I):

M¹M²Oₐ[R(COO)ₓ]_{b} (I),

wherein M¹ and M² represent metals, R(COO)ₓ represents an organic ligand, R represents the hydrocarbyl group of the organic ligand, COO represents the coordinating group of the organic ligand, x represents the number of coordinating groups in the organic ligand, a represents the molar ratio of oxygen atom linked to the metal via a non-coordination bond to the total amount of the metal, and b represents the molar ratio of the organic ligand to the total amount of the metal, wherein:
M¹ and M², being different from each other, are each independently one selected from the group consisting of Group VB metals, Group VIB metals, Group VIII metals and Group IB metals having a hydrogenation activity;
R is a C3-C19 hydrocarbyl group;
x is 1, 2 or 3, preferably 1 or 2;
a is a positive number from 0 to 5, preferably from 1 to 3; and
b is a positive number from 1 to 6, preferably from 2 to 5,
wherein the catalyst shows an infrared spectrum with characteristic peaks at positions of 700-1000 cm⁻¹, 1350-1450 cm⁻¹ and 1500-1610 cm⁻¹.

In another aspect, the present application provides a method for preparing an unsupported bimetallic hydrogenation catalyst, comprising the steps of:
1) mixing a first metal source or a dispersion thereof with an organic ligand compound;
2) reacting the mixture obtained in step 1) at a temperature T1 for a time t1;
3) reacting the material obtained in step 2) at a temperature T2 for a time t2;
4) optionally, adding a second metal source or a dispersion thereof to the material obtained in step 3) and reacting the resultant at the temperature T2 for a time t3; and
5) collecting the resulting liquid product,
wherein the first and second metal sources are each independently selected from the group consisting of elemental metal, metal oxide, metal hydroxide, metallic oxyacid, metal inorganic salt, or combinations thereof, the metals in the first and second metal sources, being the same as or different from each other, are each independently one or two selected from the group consisting of Group VB metals, Group VIB metals, Group VIII metals, and Group IB metals having a hydrogenation activity,
the organic ligand compound is selected from the group consisting of C4-C20 organic carboxylic acids or anhydrides thereof,
the molar ratio of the organic ligand compound to the total amount of metal in the first and second metal sources is 1-10:1,
the temperature T1 is 50-150° C., the time t1 is 5-180 min,
the temperature T2 is 100-350° C., the time t2 is 1-8 h,
the time t3 is 1-8 h,
with a proviso that where only the first metal source is used or the metal in the second metal source is the same as the metal in the first metal source, the metal in the first metal source is two selected from the group consisting of Group VB metals, Group VIB metals, Group VIII metals, and Group IB metals having a hydrogenation activity.

In still another aspect, the present application provides a bimetallic hydrogenation catalyst composition, comprising the unsupported bimetallic hydrogenation catalyst and at least one organic ligand compound and/or organic solvent, wherein the organic ligand compound is selected from C4-C20 organic carboxylic acids, and the organic solvent is selected from the group consisting of aliphatic hydrocarbons, aromatic hydrocarbons, alicyclic hydrocarbons, halogenated hydrocarbons, alcohol solvents, ether solvents, ester solvents, ketone solvents, or combinations thereof.

In yet another aspect, there is provided a process for hydroprocessing a hydrocarbonaceous feedstock, comprising the step of contacting the hydrocarbonaceous feedstock with the unsupported bimetallic hydrogenation catalyst or the bimetallic hydrogenation catalyst composition according to the present application for hydrogenation reaction.

In yet another aspect, the present application provides an unsupported catalyst composition, comprising, by weight, from 10% to 45% of a hydrogenation catalyst component, from 45% to 80% of a dispersion medium and from 1.0% to 10% of an activator, wherein:
the hydrogenation catalyst component is consisted of the unsupported bimetallic hydrogenation catalyst according to the present application and optionally an organic ligand compound selected from C4-C20 organic carboxylic acids,
the dispersion medium is selected from the group consisting of organic solvents, petroleum fractions or combinations thereof, the organic solvent is selected from the group consisting of aliphatic hydrocarbons, aromatic hydrocarbons, alicyclic hydrocarbons, halogenated hydrocarbons, alcohol solvents, ether solvents, ester solvents, ketone solvents or combinations thereof, the petroleum fraction is selected from distillate oils with a distillation range of 150-524° C. or residual oil components with a boiling point>524° C.,
the activator is selected from the group consisting of elemental sulfur, sulfur-containing compounds, or combinations thereof.

In yet another aspect, there is provided the use of the unsupported catalyst composition of the present application in the hydro-upgrading of heavy oils.

In yet another aspect, the present application provides a process for the hydro-upgrading of heavy oils, comprising the step of subjecting a heavy oil feedstock to a hydro-upgrading reaction under heating conditions in the presence of hydrogen and the unsupported catalyst composition of the present application, which is optionally presulphurized.

When used in hydrogenation reaction of hydrocarbons, the unsupported bimetallic hydrogenation catalyst according to the present application and its composition show high dispersibility in oil phase, stability, hydrogenation activity and selectivity to target product. Meanwhile, the method for preparing the catalyst of the present application has the advantages of small number of raw materials, simple preparation process, low material and energy consumption, and green and efficient preparation procedure; the resulting catalyst, in particular the metal complex comprised therein, has a higher metal content and better storage stability.

Other characteristics and advantages of the present application will be described in detail in the detailed description hereinbelow.

### BRIEF DESCRIPTION OF THE DRAWINGS

The drawings, forming a part of the present description, are provided to help the understanding of the present application, and should not be considered to be limiting. The present application can be interpreted with reference to the drawings in combination with the detailed description hereinbelow. In the drawings:

FIG. 1 shows an IR spectrum of the product obtained in Example 1;

FIG. 2 shows an IR spectrum of the product obtained in Example 2

FIG. 3 shows an IR spectrum of the product obtained in Example 3;

FIG. 4 shows an IR spectrum of the product obtained in Example 4;

FIG. 5 shows an IR spectrum of the product obtained in Example 5;

FIG. 6 shows an IR spectrum of the product obtained in Example 6;

FIG. 7 is an image showing the results of dissolution of the catalyst obtained in Example 1 in toluene; and

FIG. 8 is an image showing the results of dissolution of the catalyst obtained in Example 3 in toluene.

### DETAILED DESCRIPTION OF THE INVENTION

The present application will be further described hereinafter in detail with reference to the drawings and specific embodiments thereof. It should be noted that the specific embodiments of the present application are provided for illustration purpose only, and are not intended to be limiting in any manner.

Any specific numerical value, including the endpoints of a numerical range, described in the context of the present application is not restricted to the exact value thereof, but should be interpreted to further encompass all values close to said exact value, for example all values within ±5% of said exact value. Moreover, regarding any numerical range described herein, arbitrary combinations can be made between the endpoints of the range, between each endpoint and any specific value within the range, or between any two specific values within the range, to provide one or more new numerical range(s), where said new numerical range(s) should also be deemed to have been specifically described in the present application.

Unless otherwise stated, the terms used herein have the same meaning as commonly understood by those skilled in the art; and if the terms are defined herein and their definitions are different from the ordinary understanding in the art, the definition provided herein shall prevail.

In the context of the present application, in addition to those matters explicitly stated, any matter or matters not mentioned are considered to be the same as those known in the art without any change. Moreover, any of the embodiments described herein can be freely combined with another one or more embodiments described herein, and the technical solutions or ideas thus obtained are considered as part of the original disclosure or original description of the present application, and should not be considered to be a new matter that has not been disclosed or anticipated herein, unless it is clear to the person skilled in the art that such a combination is obviously unreasonable.

All of the patent and non-patent documents cited herein, including but not limited to textbooks and journal articles, are hereby incorporated by reference in their entirety.

As described above, in a first aspect, the present application provides an unsupported bimetallic hydrogenation catalyst, composed of a complex formed by bonding a metal central atom or central ion with an organic ligand through a coordination bond, wherein the metal is two selected from the group consisting of Group VB metals, Group VIB metals, Group VIII metals, and Group IB metals that have a hydrogenation activity, the organic ligand comprises a hydrocarbyl moiety and a coordinating group that is —C(═O)—O group, and forms a coordination bond with the metal central atom or central ion through an oxygen atom, wherein the catalyst has a schematic composition represented by formula (I):

M¹M²Oₐ[R(COO)ₓ]b (I),
wherein M¹ and M² represent metals, R(COO)ₓ represents an organic ligand, R represents the hydrocarbyl group of the organic ligand, COO represents the coordinating group of the organic ligand, x represents the number of coordinating groups in the organic ligand, a represents the molar ratio of oxygen atom linked to the metal via a non-coordination bond to the total amount of the metal, and b represents the molar ratio of the organic ligand to the total amount of the metal, wherein:
M¹ and M², being different from each other, are each independently one selected from the group consisting of Group VB metals, Group VIB metals, Group VIII metals and Group IB metals having a hydrogenation activity;
R is a C3-C19 hydrocarbyl group, preferably selected from the group consisting of C5-C11 normal alkyl, C5-C11 isomeric alkyl, C5-C12 alkyl with cycloalkyl moiety and C6-C12 aryl;
x is 1, 2 or 3, preferably 1 or 2;
a is a positive number from 0 to 5, preferably from 1 to 3; and
b is a positive number from 1 to 6, preferably from 2 to 5,
wherein the catalyst shows an infrared spectrum with characteristic peaks at positions of 700-1000 cm⁻¹, 1350-1450 cm⁻¹ and 1500-1610 cm⁻¹.

According to the present application, the unsupported bimetallic hydrogenation catalyst consists only of the complex and does not comprise any solid carrier component. However, if desired, the unsupported bimetallic hydrogenation catalyst of the present application can also be present and used in the form of a composition with a liquid component capable of dispersing the catalyst, such as organic solvents and organic ligand compounds.

According to the present application, the Group VB metal, Group VIB metal, Group VIII metal and Group IB metal having a hydrogenation activity in the complex of the present application may be in the form of a central atom or a central ion, depending on the metal used.

According to the present application, the unsupported bimetallic hydrogenation catalyst may be a mixture of a plurality of different complexes, and the molar ratios a and b of the oxygen atom and the organic ligand to the total amount of the metal (i.e., the total amount of the metals M¹ and M²) in the catalyst are calculated values based on analysis of the metal content and elemental composition, etc., and thus may be non-integers. In addition, M¹ and M² in the composition only indicates which metals are present while does not indicate the molar ratio between the metals.

In a preferred embodiment, at least a portion of the complex in the catalyst has a structure represented by formula (I-1):

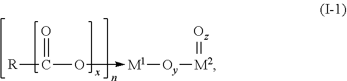

wherein M¹ and M² represent metals which, being different from each other, are each independently one selected from the group consisting of Group VB metals, Group VIB metals, Group VIII metals and Group IB metals having a hydrogenation activity;
→ represents a coordination bond;
R is a C3-C19 hydrocarbyl group, preferably selected from the group consisting of C5-C11 normal alkyl, C5-C11 isomeric alkyl, C5-C12 alkyl with cycloalkyl moiety and C6-C12 aryl;
x represents the number of coordinating groups in the organic ligand, and is 1 or 2, preferably 1;
n represents a coordination number, and is a positive number from 1 to 6, preferably from 2 to 5;
y represents the number of oxygen atom linked to both the metal M¹ and the metal M² via non-coordination bond, and is 0 or 1, preferably 1; and
z represents the number of oxygen atom linked only to the metal M² via a non-coordination bond, and is a positive number from 0 to 2, preferably 0 or 1.

In a preferred embodiment, in the infrared spectrum of the catalyst, the distance between a characteristic peak at the position of 1350-1450 cm⁻¹ and a characteristic peak at the position of 1500-1610 cm⁻¹ is more than 145 cm⁻¹.

In a preferred embodiment, the Group VB metals, Group VIB metals, Group VIII metals and Group IB metals having a hydrogenation activity are selected from the group consisting of V, Cr, Mo, W, Fe, Co, Ru, Ni, Cu and Pd, more preferably selected from the group consisting of Mo, Ni, W, Fe, V and Co.

In the present application, the term “C3-C19 hydrocarbyl” refers to a hydrocarbyl group having 3 to 19 carbon atoms, which may be saturated or unsaturated, and may be normal hydrocarbyl, isomeric hydrocarbyl, or hydrocarbyl with cycloalkyl moiety, including, but not limited to, C3-C19 normal alkyl, C3-C19 isomeric alkyl, C5-C19 alkyl with cycloalkyl moiety, and C6-C19 aryl.

In the present application, the term “C3-C19 normal alkyl” refers to a normal alkyl group having 3 to 19 carbon atoms, preferably 5 to 11 carbon atoms, such as n-pentyl, n-hexyl, n-heptyl, n-octyl, n-nonyl, n-decyl, n-undecyl.

In the present application, the term “C3-C19 isomeric alkyl” refers to a isomeric alkyl group having 3 to 19 carbon atoms, preferably 5 to 11 carbon atoms, such as isopentyl, isohexyl, isoheptyl, isooctyl, isononyl, isodecyl, isoundecyl.

In the present application, the term “C5-C19 alkyl with cycloalkyl moiety” refers to a saturated hydrocarbyl group having 5 to 19 carbon atoms, preferably 5 to 12 carbon atoms, that comprises a saturated carbon ring, such as cyclopentyl, cyclohexyl, methylcyclohexyl, decahydronaphthyl, methyldecahydronaphthyl, ethyldecahydronaphthyl, and the like.

In the present application, the term “C6-C19 aryl” refers to a hydrocarbyl group having 6 to 19 carbon atoms that comprises an aromatic ring, such as phenyl, naphthyl, anthracyl, p-tolyl, benzyl, methylnaphthyl, methylanthracenyl, and the like, preferably an aryl group of 6 to 12 carbon atoms.

According to the present application, the C3-C19 hydrocarbyl, C3-C19 normal alkyl, C3-C19 isomeric alkyl, C5-C19 alkyl with cycloalkyl moiety, and C6-C19 aryl groups may be optionally substituted, e.g., may be unsubstituted, or may be substituted with one or more groups selected from halo, nitro, sulfonic acid group, and the like.

In a preferred embodiment, the organic ligand in the complex is derived from a C4-C20 organic carboxylic acid, preferably from one or more selected from the group consisting of C4-C20 normal or isomeric alkyl carboxylic acids, C6-C20 naphthenic carboxylic acids comprising a saturated carbon ring and C7-C20 aromatic carboxylic acids comprising an aromatic ring, more preferably from one or more selected from the group consisting of C6-C12 normal or isomeric alkyl carboxylic acids, C6-C13 naphthenic carboxylic acids comprising a saturated carbon ring and C7-C13 aromatic carboxylic acids comprising an aromatic ring, further preferably from one or more selected from the group consisting of succinic acid, hexanoic acid, adipic acid, heptanoic acid, octanoic acid, nonanoic acid, ethylhexanoic acid, oleic acid, petroleum acid, salicylic acid, benzoic acid and phenylacetic acid.

In a preferred embodiment, the unsupported bimetallic hydrogenation catalyst has a metal content of from 5% to 35%, preferably from 8% to 30%, more preferably from 10% to 25%, particularly preferably from 10% to 20%, calculated based on metal and relative to the weight of the catalyst.

In a preferred embodiment, the unsupported bimetallic hydrogenation catalyst is obtained by directly reacting Group VB metals, Group VIB metals, Group VIII metals and/or Group IB metals that have a hydrogenation activity, oxides thereof, hydroxides thereof, metallic oxyacids thereof and/or metal inorganic salts thereof with an organic ligand compound selected from C4-C20 organic carboxylic acids, preferably from the group consisting of C4-C20 normal or isomeric alkyl carboxylic acids, C6-C20 naphthenic carboxylic acids comprising a saturated carbon ring, C7-C20 aromatic carboxylic acids comprising an aromatic ring, or combinations thereof.

According to the present application, the term “C4-C20 normal alkyl carboxylic acid” refers to a carboxylic acid having 4 to 20 carbon atoms obtained by linking one or more carboxyl groups to a normal alkane, such as butyric acid, succinic acid, valeric acid, hexanoic acid, adipic acid, heptanoic acid, octanoic acid, nonanoic acid, ethylhexanoic acid, tridecanoic acid, oleic acid, and the like.

According to the present application, the term “C4-C20 isomeric alkyl carboxylic acid” refers to a carboxylic acid having 4 to 20 carbon atoms obtained by linking one or more carboxyl groups to a isomeric alkane, such as isobutyric acid, isovaleric acid, isohexanoic acid, ethylhexanoic acid.

According to the present application, the term “C6-C20 naphthenic carboxylic acid comprising a saturated carbon ring” refers to a carboxylic acid having 6 to 20 carbon atoms obtained by linking one or more carboxyl groups to an alkane compound comprising a saturated carbon ring, such as cyclohexanecarboxylic acidcyclohexanoic acid, cyclohexanedicarboxylic cyclohexane dicarboxylic acid, decahydro-naphthoic aciddecahydronaphthoic acid, decahydro-naphthoic, decahydronaphthalene dicarboxylic acid.

According to the present application, the term “C7-C20 aromatic carboxylic acid comprising an aromatic ring” refers to a carboxylic acid having 7 to 20 carbon atoms obtained by linking one or more carboxyl groups to an aromatic hydrocarbon, i.e., a hydrocarbon compound comprising an aromatic ring, such as benzoic acid, phenylacetic acid, phthalic acid, phenylpropionic acid.

In a further preferred embodiment, the organic ligand compound is selected from the group consisting of C6-C12 normal or isomeric alkyl carboxylic acids, C6-C13 naphthenic carboxylic acids comprising a saturated carbon ring, C7-C13 aromatic carboxylic acids comprising an aromatic ring or combinations thereof, even more preferably selected from the group consisting of succinic acid, hexanoic acid, adipic acid, heptanoic acid, octanoic acid, nonanoic acid, ethylhexanoic acid, oleic acid, petroleum acid, salicylic acid, benzoic acid, phenylacetic acid or combinations thereof.

In a second aspect, the present application provides a method for preparing an unsupported bimetallic hydrogenation catalyst, comprising the steps of:
1) mixing a first metal source or a dispersion thereof with an organic ligand compound;
2) reacting the mixture obtained in step 1) at a temperature T1 for a time t1;
3) reacting the material obtained in step 2) at a temperature T2 for a time t2;
4) optionally, adding a second metal source or a dispersion thereof to the material obtained in step 3) and reacting the resultant at the temperature T2 for a time t3; and
5) collecting the resulting liquid product,
wherein the first and second metal sources are each independently selected from the group consisting of elemental metal, metal oxide, metal hydroxide, metallic oxyacid, metal inorganic salt, or combinations thereof, the metals in the first and second metal sources, being the same as or different from each other, are each independently one or two selected from the group consisting of Group VB metals, Group VIB metals, Group VIII metals, and Group IB metals having a hydrogenation activity,
the organic ligand compound is selected from C4-C20 organic carboxylic acids or anhydrides thereof,
the molar ratio of the organic ligand compound to the total amount of metal in the first and second metal sources is 1-10:1,
the temperature T1 is 50-150° C., preferably 80-120° C., the time t1 is 5-180 min, preferably 10-150 min,
the temperature T2 is 100-350° C., preferably 160-260° C., the time t2 is 1-8 h, preferably 2-5 h,
the time t3 is 1-8 h, preferably 2-5 h,
with a proviso that where only the first metal source is used or the metal in the second metal source is the same as the metal in the first metal source, the metal in the first metal source is two selected from the group consisting of Group VB metals, Group VIB metals, Group VIII metals, and Group IB metals having a hydrogenation activity.

By adding the pre-reaction step 2) (i.e. pre-reacting at the temperature T1 for a time t1), the method for preparing the catalyst of the present application can provide the resulting metal complex with a higher metal content and a better storage stability.

According to the present application, the pressure and reaction atmosphere used in steps 2), 3) and 4) are not particularly limited, for example, the reaction pressure may be atmospheric pressure and the reaction atmosphere may be air, nitrogen or an inert atmosphere.

In a preferred embodiment, the mixture obtained in step 1) is consisted of the first metal source and the organic ligand compound; or consisted of the first metal source, a dispersion medium for dispersing the first metal source, and the organic ligand compound.

According to the present application, the C4-C20 organic carboxylic acid used as the organic ligand compound in step 1) may be those specifically described in the first aspect of the present application. For example, in a preferred embodiment, the organic ligand compound is selected from the group consisting of C4-C20 normal or isomeric alkyl carboxylic acids, C6-C20 naphthenic carboxylic acids comprising a saturated carbon ring, C7-C20 aromatic carboxylic acids comprising an aromatic ring, or combinations thereof, preferably selected from the group consisting of C6-C12 normal or isomeric alkyl carboxylic acids, C6-C13 naphthenic carboxylic acids comprising a saturated carbon ring, C7-C13 aromatic carboxylic acids comprising an aromatic ring, or combinations thereof, more preferably selected from the group consisting of succinic acid, hexanoic acid, adipic acid, heptanoic acid, octanoic acid, nonanoic acid, ethylhexanoic acid, oleic acid, petroleum acid, salicylic acid, benzoic acid, phenylacetic acid, or combinations thereof.

According to the present application, the first and second metal sources may each independently comprise one or two Group VB, Group VIB, Group VIII or Group IB metals having a hydrogenation activity. When comparing two of those metals, the first and second metal sources may each independently be a single metal source comprising the two metals, or a mixture of two or more metal sources each comprising one or two of the metals.

In a preferred embodiment, when step 4) is used, at least a portion of the metal in the second metal source is different from the metal in the first metal source, e.g., the first metal source comprises one metal and the second metal source comprises one metal that is different from the former, or the first metal source comprises one metal and the second metal source comprises two metals, one of which is the same as the metal in the first metal source. Further preferably, the first metal source and the second metal source each comprises one metal, and the metals contained in the two metal sources are different.

According to the present application, the molar ratio of the first metal source to the second metal source, calculated based on metal, can be any value and is not particularly limited in the present application. In a preferred embodiment, the ratio of the first metal source to the second metal source is 1:1-5.

In some particular embodiments, the method comprises the steps of:
i) dispersing a first metal source into a dispersion medium to obtain a first metal source dispersion;
ii) adding an organic ligand compound into the dispersion obtained in step i), heating to a temperature T1, and reacting at the temperature T1 for a time t1;
iii) heating the material obtained in step ii) to a temperature T2, and reacting at the temperature T2 for a time t2; and
iv) cooling after the completion of the reaction, and collecting the resulting liquid product.

In some other particular embodiments, the method comprises the steps of:
i) dispersing a first metal source directly into an organic ligand compound;
ii) heating the mixture obtained in step i) to a temperature T1 and reacting at the temperature T1 for a time t1;
iii) heating the material obtained in step ii) to a temperature T2, and reacting at the temperature T2 for a time t2; and
iv) cooling after the completion of the reaction, and collecting the resulting liquid product.

In some other particular embodiments, the method comprises the steps of:
a) adding a first metal source or a dispersion thereof to an organic ligand compound;
b) heating the mixture obtained in step a) to a temperature T1 and reacting at the temperature T1 for a time t1;
c) heating the material obtained in step b) to a temperature T2, and reacting at the temperature T2 for a time t2;
d) adding a second metal source to the material obtained in step c) and reacting at the temperature T2 for a time t3; and
e) cooling after the completion of the reaction, and collecting the resulting liquid product.

According to the method of the present application, the metal inorganic salt may be an inorganic acid salt of the metal, such as chloride, sulphide, sulfate, nitrate, carbonate, or the like, or a salt of the metallic oxyacid of the metal, such as ammonium salt of the metallic oxyacid. In a preferred embodiment, the first and second metal sources are each independently selected from the group consisting of metal oxides, metal hydroxides, metal chlorides, metal sulphides, metal sulfates, metal nitrates, metal carbonates, metallic oxyacids, salts of metallic oxyacids, or combinations thereof, for example selected from the group consisting of oxides, hydroxides, chlorides, sulphides, sulfates, nitrates, and carbonates of V, Mo, W, Fe, Co, Ni, Cu, and Zn, molybdic acid, tungstic acid, various forms of ammonium molybdate, ammonium tungstate, or combinations thereof.

According to the method of the present application, the dispersion medium in the dispersion of the metal source may be an inorganic dispersion medium that may be selected from the group consisting of water, carbonic acid, hydrochloric acid, sulfuric acid, or phosphoric acid, or an organic dispersion medium that may be selected from the group consisting of aliphatic hydrocarbons, aromatic hydrocarbons, alicyclic hydrocarbons, halogenated hydrocarbons, alcohol solvents, ether solvents, ester solvents, ketone solvents, or combinations thereof, and more preferably selected from the group consisting of ethanol, toluene, xylene, petroleum ether, gasoline, diesel oil, or combinations thereof.

In a preferred embodiment, the weight ratio of dispersion medium to the first metal source in the first metal source dispersion and the weight ratio of dispersion medium to the second metal source in the second metal source dispersion are each independently 1-25:1, preferably 2-8:1.

In a preferred embodiment, the first metal source and the second metal source are used at a molar ratio of 1:1-5, calculated based on metal.

In the present application, the reaction steps are not particularly limited in terms of reaction pressure and reaction atmosphere, and for example, the reaction pressure may be atmospheric pressure and the reaction atmosphere may be air, nitrogen or an inert atmosphere.

According to the present application, the reaction can be carried out in the presence or absence of water (for example, in the presence of water at an amount of 0 to 10 times the weight of the organic ligand compound).

According to the present application, the reaction may be carried out in the absence of any other components (e.g., catalyst, basic pH modifier, etc.), in addition to the metal source, organic ligand compound, and optional solvent (e.g., water and organic solvents such as toluene, ethanol, diesel oil, etc.).

In a third aspect, the present application provides a bimetallic hydrogenation catalyst composition comprising an unsupported bimetallic hydrogenation catalyst according to the present application and at least one organic ligand compound and/or organic solvent, wherein the organic ligand compound is selected from C4-C20 organic carboxylic acids.

According to the present application, the C4-C20 organic carboxylic acid comprised as an organic ligand compound in the bimetallic hydrogenation catalyst composition may be those specifically described in the first aspect of the present application. For example, in a preferred embodiment, the organic ligand compound is selected from the group consisting of C4-C20 normal or isomeric alkyl carboxylic acids, C6-C20 naphthenic carboxylic acids comprising a saturated carbon ring, C7-C20 aromatic carboxylic acids comprising an aromatic ring, or combinations thereof, preferably selected from the group consisting of C6-C12 normal or isomeric alkyl carboxylic acids, C6-C13 naphthenic carboxylic acids comprising a saturated carbon ring, C7-C13 aromatic carboxylic acids comprising an aromatic ring, or combinations thereof, more preferably selected from the group consisting of succinic acid, hexanoic acid, adipic acid, heptanoic acid, octanoic acid, nonanoic acid, ethylhexanoic acid, oleic acid, petroleum acid, salicylic acid, benzoic acid, phenylacetic acid, or combinations thereof.

The organic solvent is not particularly limited in the present application, as long as it can disperse or be miscible with the unsupported bimetallic hydrogenation catalyst, and may be, for example, selected from the group consisting of aliphatic hydrocarbons, aromatic hydrocarbons, alicyclic hydrocarbons, halogenated hydrocarbons, alcohol solvents, ether solvents, ester solvents, ketone solvents or combinations thereof, preferably selected from the group consisting of toluene, gasoline, ethanol, diesel oil or combinations thereof.

In a preferred embodiment, the unsupported bimetallic hydrogenation catalyst is present in an amount of from 50% to 95%, preferably from 80% to 95%; and the total amount of the organic ligand compound and the organic solvent is from 5% to 50%, preferably from 5% to 20%, based on the weight of the composition.

In a preferred embodiment, the composition comprises at least one organic ligand compound, and the composition shows an infrared spectrum with characteristic peaks at positions of 700-1000 cm⁻¹, 1350-1450 cm⁻¹, 1500-1100 cm⁻¹ and 1700-1750 cm⁻¹, wherein the characteristic peaks at positions of 700-1000 cm⁻¹, 1350-1450 cm⁻¹ and 1500-1610 cm⁻¹ are characteristic peaks of the complex, and the characteristic peak at the position of 1700-1750 cm⁻¹ is a characteristic peak of the organic ligand compound.

In a further preferred embodiment, the hydrogenation catalyst composition is consisted of the unsupported bimetallic hydrogenation catalyst and at least one organic ligand compound. In this case, the composition of the hydrogenation catalyst composition may also be expressed schematically by using the formula (I), M¹M²Oₐ[R(COO)ₓ]_{b}, wherein M¹, M², a, R and x are as defined above and b represents the molar ratio of the total amount of the organic ligand and the organic ligand compound to the total amount of metals M¹ and M².

In some particular embodiments, the hydrogenation catalyst composition may further comprise other components for improving oil solubility, storage stability, and oxidation resistance, for example, organic materials having a capability of reducibility and stability such as formic acid, oxalic acid, formaldehyde, ethylenediamine, oleylamine, and the like, and said other components may be present in an amount of 0% to 80%, preferably 0% to 50%, by weight of the composition.

In a fourth aspect, there is provided the use of the unsupported bimetallic hydrogenation catalyst or bimetallic hydrogenation catalyst composition according to the present application in the hydrogenation of hydrocarbons.

In a fifth aspect, there is provided a process for hydroprocessing a hydrocarbonaceous feedstock, comprising the step of contacting the hydrocarbonaceous feedstock with an unsupported bimetallic hydrogenation catalyst or a bimetallic hydrogenation catalyst composition according to the present application for hydrogenation reaction.

According to the present application, the hydrocarbonaceous feedstock can be various unsaturated hydrocarbon compounds such as benzene, alkylbenzenes, naphthalenes, alkylnaphthalenes, anthracenes, alkyl anthracenes, and the like; or mixtures of unsaturated hydrocarbon compounds, such as crude oil, gasoline, diesel oil, vacuum gas oil, residual oil, and the like.

In a preferred embodiment, the conditions for the hydrogenation reaction include a reaction temperature of 380-430° C., an initial hydrogen pressure of 5-20 MPa, a fresh feed liquid hourly space velocity of 0.05-1.0 h⁻¹, and a catalyst concentration (calculated based on metal) of 50-10000 g/g based on the whole feed.

In a sixth aspect, the present application provides an unsupported catalyst composition comprising, by weight, from 10% to 45% of a hydrogenation catalyst component, from 45% to 80% of a dispersion medium and from 1.0% to 10% of an activator, wherein the hydrogenation catalyst component is consisted of the unsupported bimetallic hydrogenation catalyst of the present application and optionally an organic ligand compound, wherein the organic ligand compound is selected from C4-C20 organic carboxylic acids.

According to the present application, the C4-C20 organic carboxylic acid that may be comprised in the hydrogenation catalyst component as the organic ligand compound may be those specifically described in the first aspect of the present application, of which the detailed description will be omitted herein.

According to the present application, the dispersion medium suitable for use in the unsupported catalyst composition can be any liquid material capable of enhancing the dissolution, dispersion of the metal-organic complex in the unsupported bimetallic hydrogenation catalyst, including but not limited to organic solvents and petroleum fractions capable of dispersing the catalyst or being miscible with the catalyst. The organic solvent may be selected from the group consisting of aliphatic hydrocarbons, aromatic hydrocarbons, alicyclic hydrocarbons, halogenated hydrocarbons, alcohol solvents, ether solvents, ester solvents, ketone solvents, or combinations thereof, preferably selected from the group consisting of aliphatic hydrocarbons, aromatic hydrocarbons, alicyclic hydrocarbons, or combinations thereof, such as n-octane, cyclohexane, toluene, and decahydronaphthalene, and more preferably an aromatic solvent. The petroleum fraction may be selected from distillate oils having a distillation range of 150-524° C. or residual oil components having a boiling point>524° C., such as solvent gasoline, AGO fractions, LCO, oil slurry, furfural extract, atmospheric residuum, and vacuum residuum, preferably an aromatic-rich petroleum fraction.

According to the present application, the activator suitable for the unsupported catalyst composition is a material capable of activating the M-O bond in the metal-organic complex of the unsupported bimetallic hydrogenation catalyst to form a M-S bond in the hydrogenation active phase, and can be, for example, elemental sulfur, sulfur-containing compounds, mixtures of sulfur-containing compounds, or combinations thereof, preferably selected from the group consisting of thiols, thioethers, carbon disulphide, sulfur, thiopheneic compounds, or combinations thereof.

In a preferred embodiment, the hydrogenation catalyst component is present in an amount of from 10% to 45%, preferably from 10% to 30%, the dispersion medium is present in an amount of from 45% to 80%, preferably from 60% to 80%, and the activator is present in an amount of from 1.0% to 10%, preferably from 3.0% to 10.0%, based on the weight of the unsupported catalyst composition.

In a seventh aspect, there is provided the use of the unsupported catalyst composition of the present application in the hydro-upgrading of heavy oils.

In an eighth aspect, the present application provides a process for the hydro-upgrading of heavy oils, comprising the step of subjecting a heavy oil feedstock to a hydro-upgrading reaction under heating conditions in the presence of hydrogen and the unsupported hydrogenation catalyst composition of the present application, which is optionally presulphurized.

In a preferred embodiment, the conditions of the hydro-upgrading include: an amount of the unsupported catalyst composition of 50-10000 μg/g, preferably 50-3000 μg/g, calculated based on metal and relative to the weight of the heavy oil feedstock; an initial hydrogen pressure of 5-20 MPa, preferably 5-15 MPa; a reaction temperature of 360-480° C., preferably 390-450° C.; a liquid hourly space velocity of 0.05-2.0 h⁻¹, preferably 0.05-1.0 h⁻¹; and a hydrogen-to-oil volume ratio of 300-2000, preferably 500-1500.

### EXAMPLES

The present application will be further illustrated with reference to the following examples, but the present application is not limited thereto.

In the following examples, unless otherwise specified, reagents and raw materials used are commercially available products, which are chemically pure.

In the following examples, the metal content of the resulting product was measured by Inductively Coupled Plasma Optical Emission Spectrometry (ICP-OES) using a SPECTRO ARCOS SOP plasma emission spectrometer under the conditions that an optical chamber was sealed and filled with argon gas, and the measurement was performed under vertical observation at a wavelength of 130-770 nm.

In the following examples, the elemental composition of the resulting product was determined as follows: the content of element C, H was determined using Cara Erba EA1110 elemental analyzer, Italy, according to the SH0656 method; the content of element S was measured according to the energy dispersion X fluorescence spectrometry GB 17040 method; and the content of element O was measured by O-content method.

In the following examples, the IR spectra of the resulting products were measured using a NICOLET IS50 spectrometer of Thermo Fisher with a scanning wavelength of 400-4000 cm⁻¹ and 16 times of scanning. The ZnSe crystal and the HgCdTe infrared detector were used together to measure the Attenuated Total Reflectance (ATR) of the sample, with a resolution of 4 cm⁻¹.

### Examples 1 to 6 and Comparative Example 1

The compounds were weighed in the amounts shown in Table 1, placed in a three-necked flask, and reacted under the conditions shown in Table 1. After completion of the reaction, the metal compounds in the flasks of Examples 1 to 5 were completely dissolved, and unreacted metal compounds were remained in the flask of Example 6. The liquid reaction products in the flasks obtained in Examples 1 to 5 were poured out to obtain a target catalyst product; the product of Example 6 was filtered to remove unreacted metal compounds and the target catalyst product was obtained. Comparative Example 1 was carried out using the same raw materials as in Example 1 and a slightly different method. The metal contents of the catalysts were measured using inductively coupled plasma optical emission spectrometry (ICP-OES), the elemental composition of the catalysts was measured using a corresponding method, and the composition of the catalysts was determined according to the measured results of the metal content and elemental composition. The raw materials and reaction conditions used and the test results of Examples 1 to 6 and Comparative Example 1 are shown in Table 1.

TABLE 1
Raw materials, reaction conditions and results of Examples 1-6 and Comparative Example 1

| | Examples | | | | | | |
|---|---|---|---|---|---|---|---|
| | | | | | | | Comparative |
| | Example 1* | Example 2* | Example 3* | Example 4* | Example 5* | Example 6* | Example 1**** |
| Metals | Mo-Ni | Mo-Ni | Mo-Co | Mo-Fe | W-Ni | Mo-Ni | Mo-Ni |
| Raw materials | Ammonium | Ammonium | Ammonium | Molybdenum | Ammonium | Ammonium | Ammonium |
| and amounts | molybdate | heptamolybdate | heptamolybdate | trioxide | metatungstate | molybdate | molybdate |
| thereof | 8.87 g | 8.83 g | 8.84 g | 7.20 g | 13.48 g | 8.88 g | 8.84 g |
| | Nickel | Nickel | Cobalt | Ferric | Nickel | Nickel | Nickel |
| | nitrate | nitrate | nitrate | nitrate | hydroxide | nitrate | nitrate |
| | 14.50 g | 14.45 g | 14.15 g | 20.2 g | 4.640 g | 14.52 g | 14.52 g |
| | Ethyl | Isooctanoic | N-octanoic | Acetic | Oleic | Formic | Ethyl |
| | hexanoic | acid | acid | acid | acid | acid | hexanoic |
| | acid | 21.62 g | 54.02 g | 12 g | 84.65 g | 27.6 g | acid |
| | 43.68 g | | | | | | 43.68 g |
| | Water | Water | Formic | Hexanoic | — | Ethyl | Water |
| | 20 mL | 20 mL | acid | acid | | hexanoic | 20 mL |
| | | | 27.6 g | 38.3 g | | acid | |
| | | | | | | 14.5 g | |
| Reaction | 120 | 100 | 110 | 100 | 120 | 100 | — |
| temperature | | | | | | | |
| T1/° C. | | | | | | | |
| Reaction time | 60 | 30 | 15 | 40 | 10 | 30 | — |
| t1/min | | | | | | | |
| Reaction | 220 | 220 | 220 | 200 | 300 | 200 | 220 |
| temperature | | | | | | | |
| T2/° C. | | | | | | | |
| Reaction time | 1 | 3 | 3 | 1 | 5 | 4 | 4 |
| t2/h | | | | | | | |
| Reaction time | 3 | None | 3 | 2 | None | None | None |
| t3/h | | | | | | | |
| Reaction | Air | Air | Air | Air | Air | Air | Air |
| atmosphere | | | | | | | |
| Reaction | Atmospheric | Atmospheric | Atmospheric | Atmospheric | Atmospheric | Atmospheric | Atmospheric |
| pressure | pressure | pressure | pressure | pressure | pressure | pressure | pressure |
| Metal content | 15.95 | 23.9 | 16.94 | 12.30 | 14.24 | 33.3 | 14.56 |
| of the catalyst/% | | | | | | | |
| Composition | (MoNi)O_{0.9} | (MoNi)O_{0.6} | (MoCo)O_{1.27} | (MoFe)O_{1.5} | (WNi)O_{2.3} | (MoNi)O_{1.2} | (MoNi)O_{0.7} |
| of the catalyst | (i-C₇H₁₆COO)_{2.70} | (i-C₇H₁₆COO)_{1.7} | (n-C₇H₁₆COO)_{2.45} | (C₅H₁₁COO)_{3.7} | (C₁₇H₃₄COO)_{2.3} | (i-C₇H₁₆COO)_{2.0} | (i-C₇H₁₆COO)_{3.03} |

Note:
*The metal compounds were completely dissolved in Examples 1 to 5, indicating that the organic ligand compounds might be used in an excessive amount, and thus the resulting catalyst products might comprise unreacted organic ligand compounds;
**In Example 6, unreacted metal compounds were retained, and in Comparative Example 1, unreacted metal compounds were removed by filtration after the reaction, indicating that the metal compounds were used in Example 6 and Comparative Example 1 in an excessive amount, and thus the resulting catalyst products comprised only the metal-organic complex formed;
***The metal (e.g. MoNi, MoCo, MoFe, etc.) shown in the composition of the resulting catalysts only shows which metals are present while does not indicate the molar ratio between the metals.
****The raw materials used in Comparative Example 1 were the same as in Example 1, but step (2) of the method as described in Example 1 was omitted in Comparative Example 1.

As shown in Table 1, the metal content of the unsupported bimetallic catalyst or bimetallic hydrogenation catalyst composition of the present application can be 12.30-33.3%, and the molar ratio of the organic ligand to the total amount of metal in the catalyst or the molar ratio of the total amount of the organic ligand and the organic ligand compound to the total amount of metal in the catalyst is 1.7-3.7.

The elemental analysis results of the product obtained in Example 1 are shown in Table 2, and the values of a and b in the composition of the product represented by the formula (MoNi)Oₐ(i-C₇H₁₆COO)_{b} can be calculated from the data shown in Table 2, where b=0.54/(0.10+0.10)=2.70, and a=(1.26−2.0×0.54)/0.20=0.9.

TABLE 2
Elemental analysis results of the product obtained in Example 1

| | Mass | Molar | Moles of corresponding groups |
|---|---|---|---|
| Element | content/% | content/% | obtained after convertion |
| C | 51.84 | 4.32 | 4.32/8 = 0.54 |
| H | 8.74 | 8.74 | 8.74/16 = 0.54 |
| O | 20.23 | 1.26 | 1.26 |
| Mo | 9.94 | 0.10 | 0.10 |
| Ni | 6.01 | 0.10 | 0.10 |

The elemental analysis results of the catalyst obtained in Example 3 are shown in Table 3, and the values of a and b in the composition of the catalyst represented by the formula (MoCo)Oₐ(C₇H₁₆COO)_{b} can be calculated from the data shown in Table 3, where b=0.54/(0.11+0.11)=2.45 and a=(1.36−2.0×0.54)/0.22=1.27.

TABLE 3
Elemental analysis results of the catalyst obtained in Example 3

| | Mass | Molar | Moles of corresponding groups |
|---|---|---|---|
| Element | content/% | content/% | obtained after convertion |
| C | 51.85 | 4.32 | 4.32/8 = 0.54 |
| H | 8.64 | 8.64 | 8.64/16 = 0.54 |
| O | 21.79 | 1.36 | 1.36 |
| Mo | 10.56 | 0.11 | 0.11 |
| Co | 6.38 | 0.11 | 0.11 |

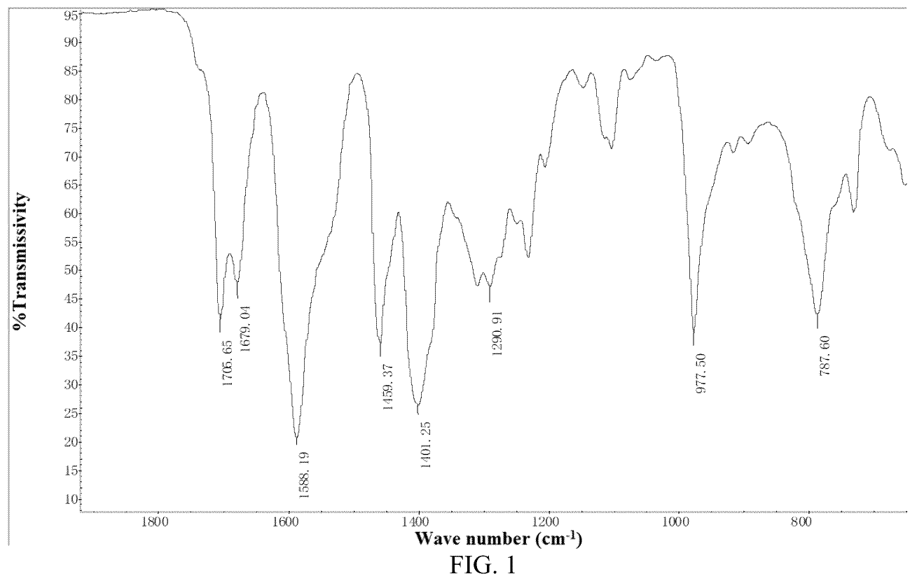

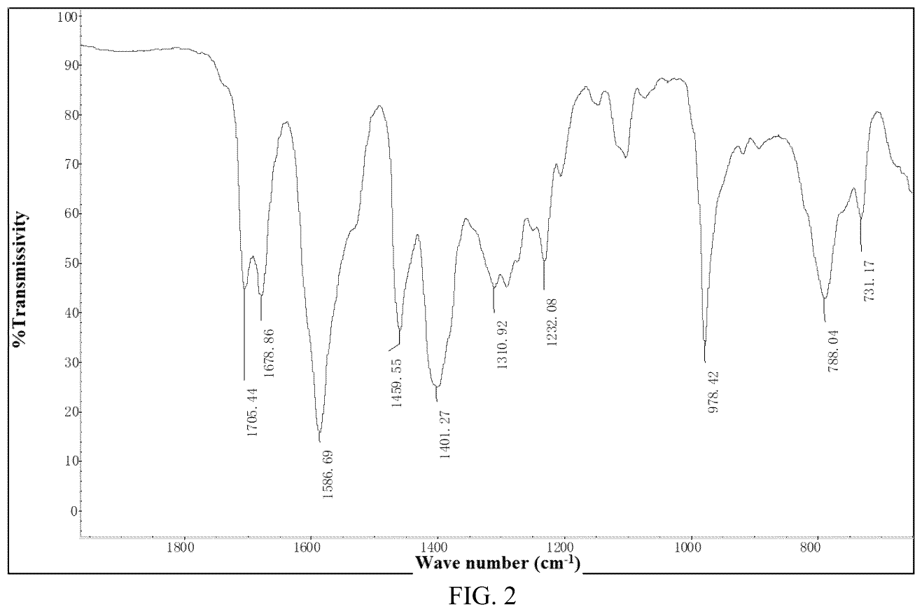

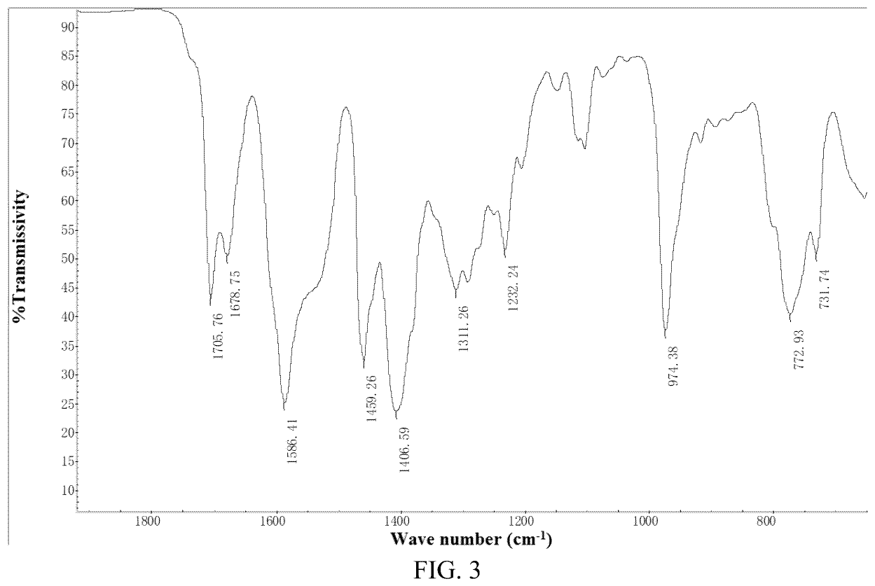

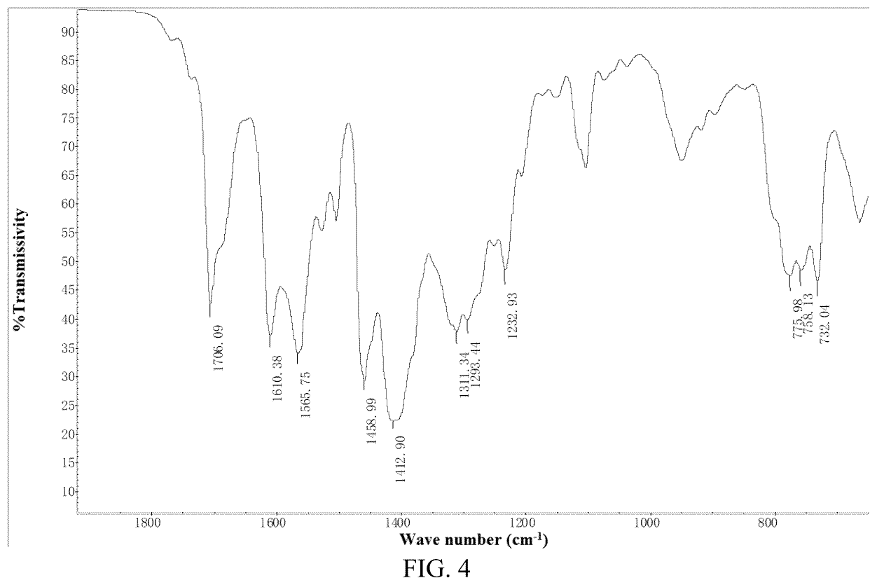

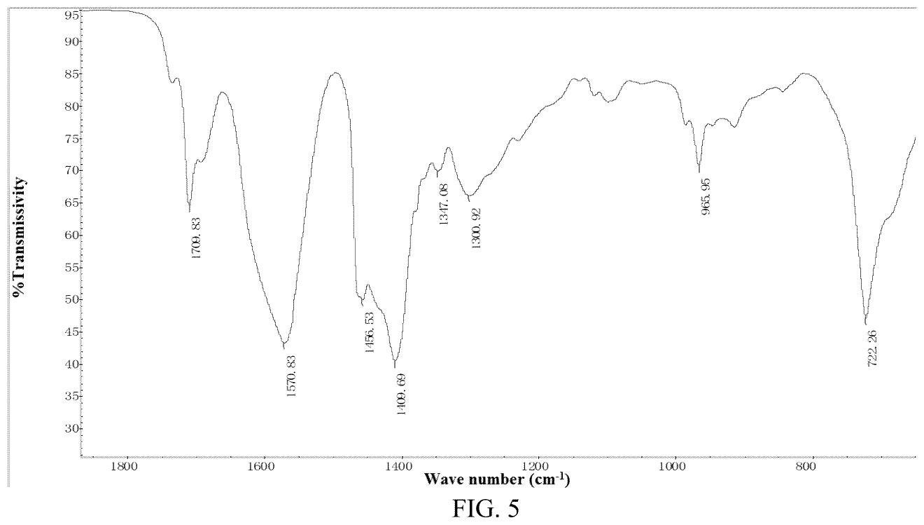

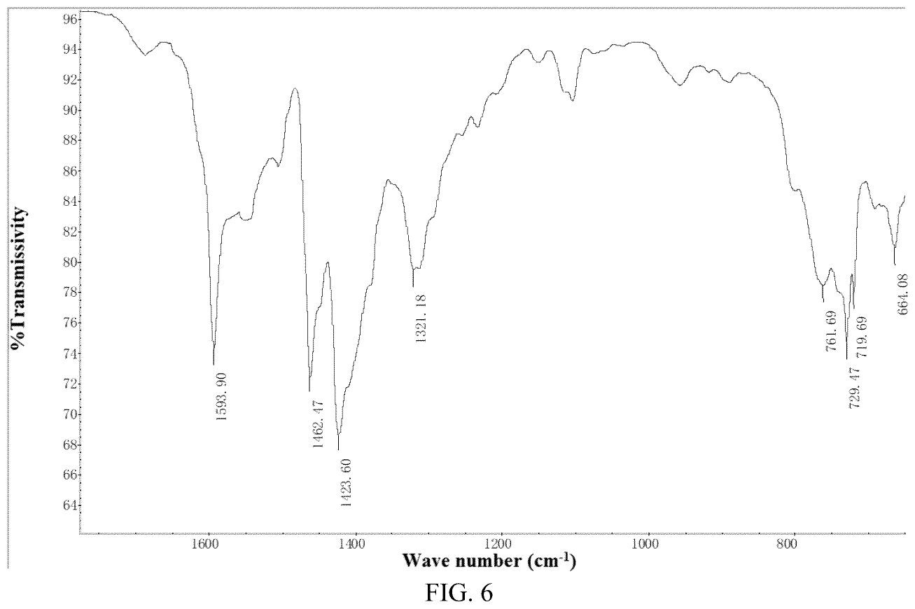

The IR spectra of the catalysts obtained in Examples 1-6 are shown in FIGS. 1-6, and can be clearly seen from FIGS. 1-6 that the catalysts of all examples show characteristic peaks at positions of 700-1000 cm⁻¹, 1350-1450 cm⁻¹ and 1500-1610 cm⁻¹.

As shown in FIG. 1, the catalyst of Example 1 shows a M-O vibrational characteristic peak at the position of 700-1000 cm⁻¹ and characteristic peaks of the coordination between the —C(═O)—O group and the metal at positions of 1350-1450 cm⁻¹ and 1500-1610 cm⁻¹, and the distance between a characteristic peak at the position of 1350-1450 cm⁻¹ and a characteristic peak at the position of 1500-1610 cm⁻¹ (i.e. the difference of the wave numbers corresponding to the positions of the crest of those peaks) is more than 145 cm⁻¹, indicating that a complex having a monodentate coordination structure represented by the following formula is present in the catalyst:

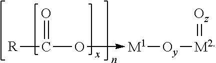

The data in Table 1 show that, by adding the step (2) (i.e., pre-reaction at a temperature T1 for a time t1) in the preparation of the catalyst, the complex obtained in Example 1 has a higher metal content as compared to that obtained in Comparative Example 1. The data in Table 4 show that the complex obtained in Example 1 shows a higher storage stability as compared to the complex obtained in Comparative Example 1.

TABLE 4
Change of stability after three-month storage of the complex

| Catalyst | Example 1 | Comparative Example 1 |
|---|---|---|
| Metal content before storage | 15.95% | 14.56% |
| Metal content after storage | >15.75% | 14% |
| Change of stability*/percent | <0.2 | 0.56 |
| point | | |

*Note:
the change of stability refers to the change of the total metal content of the complex after storage for 3 months as compared to the initial content before storage as determined by elemental analysis.

### Examples 7 to 8

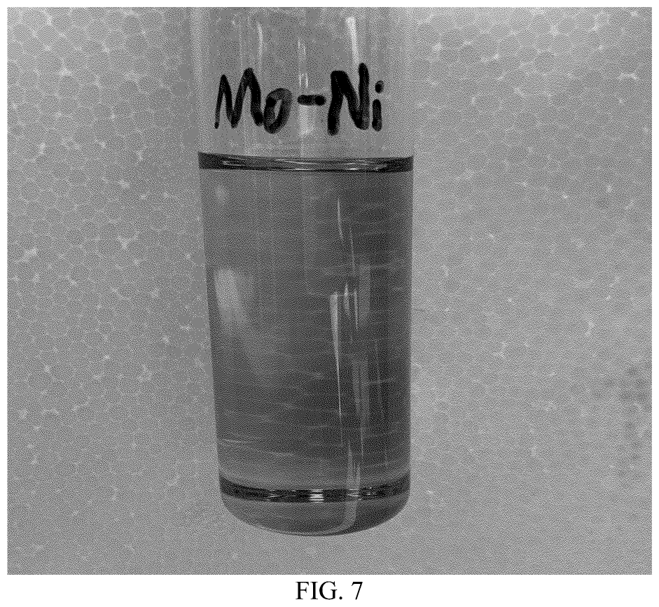

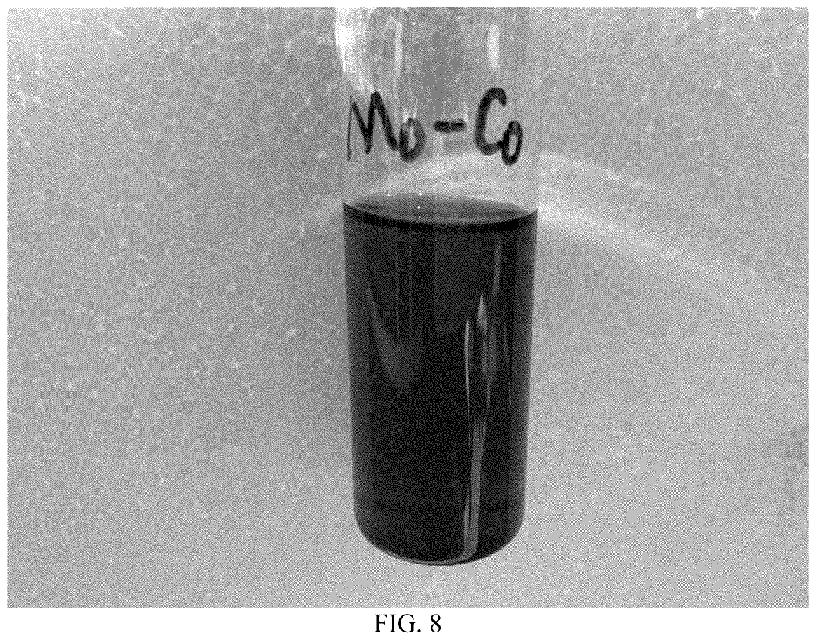

The catalyst products obtained in Example 1 and Example 3 were dispersed in toluene, respectively, to evaluate the oil solubility of the unsupported hydrogenation catalyst obtained by the method of the present application. The dissolution and dispersion results of the products of Example 1 and Example 3 in toluene are shown in FIG. 7 and FIG. 8, respectively. As can be seen from the figures, the unsupported hydrogenation catalyst synthesized according to the present application is completely miscible with toluene, indicating that the unsupported hydrogenation catalyst has good oil solubility.

### Examples 9 to 10

The products obtained in Examples 1 and 4 were used as catalysts for the hydrogenation of an aromatic hydrocarbon, i.e. phenanthrene, wherein tetralin was used as solvent, the mass fraction of phenanthrene in 10 g of total reactants (phenanthrene+solvent) was 10%, and the reaction was carried out in a 100 ml continuously stirred autoclave under test conditions including an initial hydrogen pressure of 9 MPa, a reaction temperature of 420° C., a reaction time of 60 min, and a catalyst concentration (calculated based on metal) of 2500 μg/g relative to the weight of total reactants. The test results are shown in Table 5.

### Comparative Example 2

The test was conducted as described in Example 9, except that the product obtained in Example 1 was replaced with a conventional supported catalyst (Ni—Mo supported catalyst for hydrogenation of residual oil, with a Mo content of 9.30% by mass, a Ni content of 2.52% by mass) in an equivalent substitution manner in terms of the amount of the metal. The test results are shown in Table 5.

TABLE 5
Results of Examples 9 to 10 and Comparative Example 2

| | | | Comparative |
|---|---|---|---|
| Item | Example 9 | Example 10 | Example 2 |
| Catalyst | Product of | Product of | Ni—Mo supported |
| | Example 1 | Example 4 | catalyst |
| Test results | | | |
| Phenanthrene | 56.98 | 49.56 | 28.48 |
| conversion/% | | | |
| Product distribution/% | | | |
| Dihydrophenanthrene | 23.00 | 23.12 | 23.23 |
| Tetrahydrophenanthrene | 19.05 | 14.69 | 5.25 |
| Octahydrophenanthrene | 14.93 | 11.75 | 0 |
| Change of the moles of | +98.10 | +72.15 | Reference |
| hydrogenated | | | |
| product/%) | | | |

As can be seen from the results in Table 5, the unsupported bimetallic catalyst of the present application shows higher phenanthrene conversion and higher yield of deep hydrogenation product, as compared to the supported catalyst; compared with the supported catalyst, the moles of hydrogenated phenanthrene are increased by 72-98%.

### Examples 11 to 12

The product obtained in Example 1 and an organic ligand compound (i.e. ethyl hexanoic acid) were formulated into a composition at a mass ratio of 95:5, the composition and the product obtained in Example 6 were respectively used as catalysts to catalyze the hydrocracking reaction of an alkyl substituted aromatic hydrocarbon, i.e. dodecyl pyrene, wherein decahydronaphthalene was used as a solvent, the mass fraction of dodecyl pyrene in 10 g of total reactants (dodecyl pyrene+solvent) was 10%, the reaction was carried out in a 100 ml autoclave with stirring under test conditions including an initial hydrogen pressure of 9 MPa, a reaction temperature of 420° C., a reaction time of 60 min, and a catalyst concentration (calculated based on metal) of 2500 μg/g based on the weight of the total reactants. The test results are shown in Table 6.

TABLE 6
Results of Examples 11 to 12

| Item | Example 11 | Example 12 |
|---|---|---|
| Catalyst | 95% of the product | Product of |
| | of Example 1 + | Example 6 |
| | 5% of organic ligand | |
| | compound | |
| Results of dodecyl pyrene test | | |
| Conversion of cracking/% | 100 | 100 |
| Condensation rate/% | 0 | 0 |
| Hydrogen | 2.52 | 1.68 |
| consumption/mmol | | |

From the results of Table 6, it can be seen that both the unsupported bimetallic catalyst of the present application and its composition can achieve a conversion of dodecyl pyrene cracking of 100% and a dodecyl pyrene condensation rate of zero; compared with the product of Example 6, the catalyst composition being further added with the organic ligand compound shows a higher hydrogen consumption, indicating that the catalyst composition of the present application has a higher hydrogen activating activity as compared to the catalyst itself, and the hydrogen consumption is higher under the same conditions.

### Examples 13 to 15

A residual oil catalytic hydro-thermal conversion test was carried out in a 2 L batch autoclave with stirring under the catalyst and reaction conditions shown in Table 7, using 200 g of vacuum residuum A having an asphaltene content of 14%, a Conradson carbon residue value of 26.4%, and a heavy metal (Ni+V) content of 210 μg/g as a feedstock. The test results are shown in Table 7.

### Comparative Example 3

The test was conducted as described in Example 13, except that the catalyst used in Example 13 was replaced with a conventional supported catalyst (Ni—Mo supported catalyst for hydrogenation of residual oil, with a Mo content of 9.300 by mass, a Ni content of 2.5200 by mass). The test results are shown in Table 7.

TABLE 7
Results of Examples 13 to 15 and Comparative Example 3

| | Exam- | Exam- | Exam- | Comparative |
|---|---|---|---|---|
| Item | ple 13 | ple 14 | ple 15 | Example 3 |
| Catalyst | Product of | Product of | Product of | Ni—Mo |
| | Example 2 | Example 3 | Example 4 | supported |
| | | | | catalyst |
| Reaction | 425 | 425 | 425 | 425 |
| temperature/° C. | | | | |
| Reaction time/min | 130 | 130 | 130 | 130 |
| Initial hydrogen | 9 | 9 | 9 | 9 |
| pressure | | | | |
| Amount of catalyst | 2500 | 2500 | 3300 | 2500 |
| (calculated based | | | | |
| on metal)/(μg/g) | | | | |
| Cracking rate of | 66.20 | 69.97 | 70.12 | 62.16 |
| residual oil/% | | | | |
| Coke rate/% | 0.72 | 0.93 | 0.364 | 4.06 |
| Yield of distillate | 58.25 | 60.91 | 61.14 | 52.68 |
| oil/% | | | | |

As can be seen from the results of Table 7, the unsupported bimetallic hydrogenation catalyst of the present application shows higher cracking rate of residual oil, lower coke rate and higher yield of distillate oil under the same reaction conditions as compared to the conventional supported catalyst.

### Examples 16 to 18

Unsupported hydrogenation catalyst compositions were formed using the catalyst products of Examples 1 and 6, dispersion mediums and activators, and the content of each component in the unsupported hydrogenation catalyst compositions obtained are shown in Table 8.

TABLE 8
Composition of the catalyst compositions
obtained in Examples 16-18

| Item | Example 16 | Example 17 | Example 18 |
|---|---|---|---|
| Hydrogenation | Product of | Product of | Product of |
| catalyst | Example 1, | Example 1, | Example 6, |
| component and | 14% | 37% | 40% |
| content thereof | | | |
| (wt %) | | | |
| Dispersion | LCO, 81% | Furfural | Furfural |
| medium and | | extract, 53% | extract, 50% |
| content thereof | | | |
| (wt %) | | | |
| Activator and | DMDS, 5% | Sulfur powder, | Sulfur powder, |
| content thereof | | 10% | 10% |
| (wt %) | | | |

### Example 19

The catalyst composition obtained in Example 17 was subjected to a presulphurization treatment at a reaction temperature of 360° C., an initial hydrogen pressure of 5 MPa, and a reaction time of 30 min, and the reaction product was collected after the completion of the test.

### Examples 20 to 23

The catalyst composition products of Examples 17, 18 and 19 and the catalyst product of Example 1 were mixed with 200 g of a vacuum residuum B feedstock having an asphaltene content of 12.8%, a Conradson carbon residue value of 26.3% and a heavy metal (Ni+V) content of 220 μg/g, respectively, and subjected to a vacuum residuum hydro-thermal conversion test in a 2 L batch autoclave at a reaction temperature of 425° C., an initial hydrogen pressure of 9 MPa and a reaction time of 130 min. The test results are shown in Table 9.

TABLE 9
Reaction conditions and results of Examples 20-23

| Residual oil hydro- | | | | |
|---|---|---|---|---|
| thermal conversion test | Example 20 | Example 21 | Example 22 | Example 23 |
| Catalyst | Product of | Product of | Product of | Product of |
| | Example 17 | Example 1 | Example 18 | Example 19 |
| Amount of catalyst | 1500 | 1500 | 1500 | 1500 |
| added/(calculated based | | | | |
| on metal, μg/g) | | | | |
| Reaction temperature/° C. | 425 | 425 | 425 | 425 |
| Initial hydrogen | 9 | 9 | 9 | 9 |
| pressure/MPa | | | | |
| Reaction time/min | 130 | 130 | 130 | 130 |
| Reaction results | | | | |
| Conversion of residual | 68.28 | 64.59 | 66.74 | 69.36 |
| oil/% | | | | |
| Coke rate/% | 0.57 | 1.08 | 0.78 | 0.46 |
| Asphaltene upgrading | 83.55 | 68.49 | 70.65 | 85.37 |
| Rate/% | | | | |

From a comparison between the results of Example 21 and Example 20 shown in Table 9, it can be seen that the unsupported catalyst composition product of Example 17 comprising an activator shows a slightly higher residual oil conversion rate, a higher asphaltene upgrading rate and a lower coke rate, and the coke rate is reduced by 4700, compared to the product of Example 1 free of the activator, indicating that it has a better performance for inhibiting asphaltene condensation reaction.

Meanwhile, as can be seen from a comparison between the results of Example 22 and Example 20 shown in Table 9, the unsupported catalyst composition product of Example 17, which comprises an organic ligand compound (i.e., ethylhexanoic acid), shows a higher residual oil conversion rate and asphaltene upgrading rate, and a lower coke rate, as compared to the unsupported catalyst composition product of Example 18, which does not comprise the organic ligand compound.

In addition, as can be seen from a comparison between the results of Example 23 and Example 20 shown in Table 9, where the unsupported catalyst composition product of Example 17 has been subjected to a presulphurization treatment, the residual oil conversion rate and asphaltene upgrading rate can be further improved, and the coke rate can be further reduced.

The present application is illustrated in detail hereinabove with reference to preferred embodiments, but is not intended to be limited to those embodiments. Various modifications may be made following the inventive concept of the present application, and these modifications shall be within the scope of the present application.

It should be noted that the various technical features described in the above embodiments may be combined in any suitable manner without contradiction, and in order to avoid unnecessary repetition, various possible combinations are not described in the present application, but such combinations shall also be within the scope of the present application.

In addition, the various embodiments of the present application can be arbitrarily combined as long as the combination does not depart from the spirit of the present application, and such combined embodiments should be considered as the disclosure of the present application.

1. An unsupported bimetallic hydrogenation catalyst, composed of a complex formed by bonding a metal central atom or central ion with an organic ligand through a coordination bond, wherein the catalyst has a schematic composition represented by formula (I):
M¹M²Oₐ[R(COO)ₓ]_{b} (I),
wherein M¹ and M² represent metals, R(COO)ₓ represents an organic ligand, R represents the hydrocarbyl group of the organic ligand, COO represents the coordinating group of the organic ligand, x represents the number of coordinating groups in the organic ligand, a represents the molar ratio of oxygen atom linked to the metal via a non-coordination bond to the total amount of the metal, and b represents the molar ratio of the organic ligand to the total amount of the metal, wherein:
M¹ and M², being different from each other, are each independently one selected from the group consisting of Group VB metals, Group VIB metals, Group VIII metals and Group IB metals having a hydrogenation activity;
R is a C3-C19 hydrocarbyl group, preferably selected from the group consisting of C5-C11 normal alkyl, C5-C11 isomeric alkyl, C5-C12 alkyl with cycloalkyl moiety and C6-C12 aryl;
x is 1, 2 or 3, preferably 1 or 2;
a is a positive number from 0 to 5, preferably from 1 to 3; and
b is a positive number from 1 to 6, preferably from 2 to 5,
wherein the catalyst shows an infrared spectrum with characteristic peaks at positions of 700-1000 cm⁻¹, 1350-1450 cm⁻¹ and 1500-1610 cm⁻¹.

2. The unsupported bimetallic hydrogenation catalyst according to claim 1, wherein at least a portion of the complex in the catalyst has a structure represented by formula (I-1): 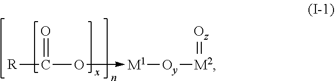
wherein M¹, M², R and x are as previously defined;
→ represents a coordination bond;
x represents the number of coordinating groups in the organic ligand, and is 1 or 2, preferably 1;
n represents a coordination number, and is a positive number from 1 to 6, preferably from 2 to 5;
y represents the number of oxygen atom linked to both the metal M¹ and the metal M² via non-coordination bond, and is 0 or 1, preferably 1; and
z represents the number of oxygen atom linked only to the metal M² via a non-coordination bond, and is a positive number from 0 to 2, preferably 0 or 1.

3. The unsupported bimetallic hydrogenation catalyst according to claim 1, wherein in the IR spectrum of the catalyst, the distance between a characteristic peak at the position of 1350-1450 cm⁻¹ and a characteristic peak at the position of 1500-1610 cm⁻¹ is more than 145 cm⁻¹.

4. The unsupported bimetallic hydrogenation catalyst according to claim 1, wherein the Group VB metals, Group VIB metals, Group VIII metals, and Group IB metals having a hydrogenation activity are selected from the group consisting of V, Cr, Mo, W, Fe, Co, Ru, Ni, Cu, and Pd, preferably selected from the group consisting of Mo, Ni, W, Fe, V, and Co.

5. The unsupported bimetallic hydrogenation catalyst according to claim 1, wherein the organic ligand is derived from a C4-C20 organic carboxylic acid, preferably from one or more selected from the group consisting of C4-C20 normal or isomeric alkyl carboxylic acids, C6-C20 naphthenic carboxylic acids comprising a saturated carbon ring and C7-C20 aromatic carboxylic acids comprising an aromatic ring, more preferably from one or more selected from the group consisting of C6-C12 normal or isomeric alkyl carboxylic acids, C6-C13 naphthenic carboxylic acids comprising a saturated carbon ring and C7-C13 aromatic carboxylic acids comprising an aromatic ring, further preferably from one or more selected from the group consisting of succinic acid, hexanoic acid, adipic acid, heptanoic acid, octanoic acid, nonanoic acid, ethylhexanoic acid, oleic acid, petroleum acid, salicylic acid, benzoic acid and phenylacetic acid.

6. The unsupported bimetallic hydrogenation catalyst according to claim 1, wherein the catalyst has a metal content of from 5% to 35%, preferably from 8% to 30%, more preferably from 10% to 25%, particularly preferably from 10% to 20%, calculated based on metal and relative to the weight of the catalyst.

7. A method for preparing the unsupported bimetallic hydrogenation catalyst according to claim 1, comprising the steps of:
1) mixing a first metal source or a dispersion thereof with an organic ligand compound;
2) reacting the mixture obtained in step 1) at a temperature T1 for a time t1;
3) reacting the material obtained in step 2) at a temperature T2 for a time t2;
4) optionally, adding a second metal source or a dispersion thereof to the material obtained in step 3) and reacting the resultant at the temperature T2 for a time t3; and
5) collecting the resulting liquid product,
wherein the first and second metal sources are each independently selected from the group consisting of elemental metal, metal oxide, metal hydroxide, metallic oxyacid, metal inorganic salt, or combinations thereof, the metals in the first and second metal sources, being the same as or different from each other, are each independently one or two selected from the group consisting of Group VB metals, Group VIB metals, Group VIII metals, and Group IB metals having a hydrogenation activity,
the organic ligand compound is selected from C4-C20 organic carboxylic acids or anhydrides thereof, preferably selected from the group consisting of C4-C20 normal or isomeric alkyl carboxylic acids, C6-C20 naphthenic carboxylic acids comprising a saturated carbon ring, C7-C20 aromatic carboxylic acids comprising an aromatic ring, anhydrides thereof or combinations thereof,
the molar ratio of the organic ligand compound to the total amount of metal in the first and second metal sources is 1-10:1,
the temperature T1 is 50-150° C., preferably 80-120° C., the time t1 is 5-180 min, preferably 10-150 min,
the temperature T2 is 100-350° C., preferably 160-260° C., the time t2 is 1-8 h, preferably 2-5 h,
the time t3 is 1-8 h, preferably 2-5 h,
with a proviso that where only the first metal source is used or the metal in the second metal source is the same as the metal in the first metal source, the metal in the first metal source is two selected from the group consisting of Group VB metals, Group VIB metals, Group VIII metals, and Group IB metals having a hydrogenation activity.

8. The method according to claim 7, wherein the mixture obtained in step 1) is consisted of the first metal source and the organic ligand compound; or
the mixture obtained in step 1) is consisted of the first metal source, a dispersion medium for dispersing the first metal source, and the organic ligand compound.

9. The method according to claim 7, wherein the first and second metal sources are each independently selected from the group consisting of elemental metal, metal oxide, metal hydroxide, metal chloride, metal sulphide, metal sulfate, metal nitrate, metal carbonate, metallic oxyacid, salt of metallic oxyacid, or combinations thereof.

10. The method according to claim 7, wherein when a dispersion of a metal source is used, the dispersion medium in the dispersion is an inorganic dispersion medium selected from the group consisting of water, carbonic acid, hydrochloric acid, sulfuric acid or phosphoric acid or an organic dispersion medium selected from the group consisting of ethanol, toluene, xylene, petroleum ether, gasoline, diesel oil, or combinations thereof,
preferably, the weight ratio of the dispersion medium in the dispersion of the first metal source to the first metal source and the weight ratio of the dispersion medium in the dispersion of the second metal source to the second metal source are each independently 1-25:1, more preferably 2-8:1.

11. The method according to claim 7, wherein the first metal source and the second metal source are used at a molar ratio of 1:1-5, calculated based on metal.

12. A bimetallic hydrogenation catalyst composition, comprising the unsupported bimetallic hydrogenation catalyst according to claim 1 and at least one organic ligand compound and/or organic solvent, wherein:
the organic ligand compound is selected from C4-C20 organic carboxylic acids, preferably selected from the group consisting of C4-C20 normal or isomeric alkyl carboxylic acids, C6-C20 naphthenic carboxylic acids comprising a saturated carbon ring, C7-C20 aromatic carboxylic acids comprising an aromatic ring or combinations thereof, more preferably selected from the group consisting of C6-C12 normal or isomeric alkyl carboxylic acids, C6-C13 naphthenic carboxylic acids comprising a saturated carbon ring, C7-C13 aromatic carboxylic acids comprising an aromatic ring or combinations thereof, further preferably selected from the group consisting of succinic acid, hexanoic acid, adipic acid, heptanoic acid, octanoic acid, nonanoic acid, ethylhexanoic acid, oleic acid, petroleum acid, salicylic acid, benzoic acid, phenylacetic acid or combinations thereof;
the organic solvent is selected from the group consisting of aliphatic hydrocarbons, aromatic hydrocarbons, alicyclic hydrocarbons, halogenated hydrocarbons, alcohol solvents, ether solvents, ester solvents, ketone solvents or combinations thereof, preferably selected from the group consisting of toluene, gasoline, ethanol, diesel oil or combinations thereof.

13. The composition according to claim 12, wherein the composition comprises at least one organic ligand compound and the composition shows an infrared spectrum with characteristic peaks at positions of 700-1000 cm⁻¹, 1350-1450 cm⁻¹, 1500-1610 cm⁻¹ and 1700-1750 cm⁻¹.

14. The composition according to claim 12, wherein the unsupported bimetallic hydrogenation catalyst is present in an amount of from 50% to 95%, preferably from 80% to 95%; and the total amount of the organic ligand compound and the organic solvent is from 5% to 50%, preferably from 5% to 20%, based on the weight of the composition.

15. A method for hydroprocessing a hydrocarbonaceous feedstock, comprising the step of contacting a hydrocarbonaceous feedstock with the unsupported bimetallic hydrogenation catalyst according to claim 1 for hydrogenation reaction, wherein the hydrocarbonaceous feedstock is an unsaturated hydrocarbon compound such as benzene, alkylbenzene, naphthalene, alkylnaphthalene, anthracene, alkylanthracene, and the like; or a mixture comprising unsaturated hydrocarbon compounds such as crude oil, gasoline, diesel oil, vacuum gas oil, residual oil, and the like.

16. An unsupported catalyst composition suitable for the hydrogenation of heavy oils, comprising, by weight, from 10% to 45% of a hydrogenation catalyst component, from 45% to 80% of a dispersion medium and from 1.0% to 10% of an activator, wherein:
the hydrogenation catalyst component is consisted of the unsupported bimetallic hydrogenation catalyst according to claim 1 and optionally an organic ligand compound, wherein the organic ligand compound is selected from C4-C20 organic carboxylic acids,
the dispersion medium is selected from the group consisting of organic solvents, petroleum fractions or combinations thereof, the organic solvent is selected from the group consisting of aliphatic hydrocarbons, aromatic hydrocarbons, alicyclic hydrocarbons, halogenated hydrocarbons, alcohol solvents, ether solvents, ester solvents, ketone solvents or combinations thereof, the petroleum fraction is selected from distillate oils with a distillation range of 150-524° C. or residual oil components with a boiling point>524° C.,
the activator is selected from the group consisting of elemental sulphur, sulphur-containing compounds, or combinations thereof, preferably selected from the group consisting of thiols, thioethers, carbon disulphide, sulphur, thiophenic compounds, or combinations thereof.

17. The unsupported catalyst composition according to claim 16, wherein the organic ligand compound is selected from the group consisting of C4-C20 normal or isomeric alkyl carboxylic acids, C6-C20 naphthenic carboxylic acids comprising a saturated carbon ring, C7-C20 aromatic carboxylic acids comprising an aromatic ring, or combinations thereof, preferably selected from the group consisting of C6-C12 normal or isomeric alkyl carboxylic acids, C6-C13 naphthenic carboxylic acids comprising a saturated carbon ring, C7-C13 aromatic carboxylic acids comprising an aromatic ring, or combinations thereof, further preferably selected from the group consisting of succinic acid, hexanoic acid, adipic acid, heptanoic acid, octanoic acid, nonanoic acid, ethylhexanoic acid, oleic acid, petroleum acid, salicylic acid, benzoic acid, phenylacetic acid, or combinations thereof.

18. The unsupported catalyst composition according to claim 16, wherein the hydrogenation catalyst component has a metal content of from 5% to 35%, preferably from 8% to 30%, more preferably from 10% to 25%, particularly preferably from 10% to 20%, and an organic ligand compound content of from 0% to 50%, preferably from 5% to 50%, more preferably from 5% to 20%, based on the weight of the hydrogenation catalyst component.

19. (canceled)

20. Use the unsupported catalyst composition according to claim 16 in the hydro-upgrading of heavy oils.

21. A process for the hydro-upgrading of heavy oils, comprising the step of subjecting a heavy oil feedstock to a hydro-upgrading reaction under heating conditions in the presence of hydrogen and the unsupported catalyst composition according to claim 16, which is optionally presulphurized.

22. The use according to claim 20, wherein the conditions of the hydro-upgrading include: an amount of the unsupported catalyst composition of 50-10000 μg/g, calculated based on metal and relative to the weight of the heavy oil feedstock, an initial hydrogen pressure of 5-20 MPa, a reaction temperature of 360-480° C., a liquid hourly space velocity of 0.05-2.0 h⁻¹, and a hydrogen-to-oil volume ratio of 300-2000;
preferably, the conditions of the hydro-upgrading include: an amount of the unsupported catalyst composition of 50-3000 μg/g, calculated based on metal and relative to the weight of the heavy oil feedstock, an initial hydrogen pressure of 5-15 MPa, a reaction temperature of 390-450° C., a liquid hourly space velocity of 0.05-1.0 h⁻¹, and a hydrogen-to-oil volume ratio of 500-1500.
